(19) United States
(12) Patent Application Publication
(10) Pub. No.: US 2007/0266343 A1
(43) Pub. Date: Nov. 15, 2007

(54) Displaying apparatus

(75) Inventor: Kiyoyuki Isoda, Kanagawa-ken (JP)

Correspondence Address: THE NATH LAW GROUP, 112 South West Street, Alexandria, VA, 22314, US

(73) Assignee: VICTOR COMPANY OF JAPAN, LIMITED, Yokohama-shi (JP)

(21) Appl. No.: 11/798,385

(22) Filed: May 14, 2007

(30) Foreign Application Priority Data
May 15, 2006 (JP) P2006-135140

(51) Int. Cl. G05B 11/01

(52) U.S. Cl. 715/838; 700/14

(57) ABSTRACT

A display apparatus includes a time difference calculator to calculate, according to temporal information of first and second contents, a time difference between creation time of the first content and creation time of the second content, a correlation value calculator to calculate, according to the calculated time difference and a given calculation formula, a correlation value for the temporal information of the first and second contents, a symbol generator to generate a symbol representing the calculated correlation value, a thumbnail generator to generate thumbnails representing the first and second contents, and a display controller to display a thumbnail view showing the thumbnails with the generated symbol arranged between the thumbnails.

### BACKGROUND OF THE INVENTION

1. Field of the Invention

The present invention relates to a display apparatus for displaying a thumbnail view showing a plurality of thumbnails each representing a content and temporal relationships among the contents along a time axis.

2. Description of Related Art

Improvements in semiconductor technology have increased the capacity of storage devices. The increased storage capacity allows a user to store many contents such as still images and movies photographed with, for example, a digital camera in a single storage device. There is a digital camera that is capable of displaying thumbnails representing a plurality of contents stored in a storage device. When the storage device stores many contents, it is difficult for the user to grasp from the thumbnails temporal relationships among the contents along a time axis. The thumbnails show no shooting date and time, and therefore, the user is unable to know if adjacent contents have been photographed on the same day, or if they have been photographed at different time points separated by a long span.

There is an opportunity to extract specific scenes from a long movie and combine the extracted scenes into a digest. From the digest, thumbnails representing the scenes may be prepared. The thumbnails, however, are unable to show temporal relationships along a time axis among the scenes. For example, it is incomprehensible from adjacent thumbnails whether scenes represented with the thumbnails have been photographed at short or long intervals.

One method of displaying temporal relationships among a plurality of contents is a technique of displaying, in addition to thumbnails of the contents, a time chart employing a time axis on which shooting time points of the contents are depicted. This technique is disclosed in, for example, Japanese Unexamined Patent Application Publication No. 2005-293313. According to the technique, a user can grasp a relationship between contents on the time axis only after associating the time chart with thumbnails of the contents. This is laborious work for the user. The time chart occupies a certain display area, to reduce the number of thumbnails to display. This results in increasing the number of switching operations when displaying temporal relationships of many contents.

One method of rearranging and displaying a plurality of contents is a technique of sorting and displaying the contents according to timestamps associated with the contents. This technique is disclosed in, for example, Japanese Unexamined Patent Application Publication No. 2004-355493. According to the technique, contents are sorted according to temporal ranges, and therefore, it is unable to grasp a relationship between contents that are sorted into the same temporal range. In addition, the technique asks the user to set the temporal ranges for sorting contents.

In this way, none of the related arts allows a user to easily grasp temporal relationships of a plurality of contents stored in a storage device.

### SUMMARY OF THE INVENTION

An object of the present invention is to provide a display apparatus capable of displaying a thumbnail view showing thumbnails each representing a content in such a way as to allow a user to easily understand temporal relationships of the contents.

In order to accomplish the object, a first aspect of the present invention provides a display apparatus having a function of displaying a thumbnail view according to content data, the content data including a plurality of contents and temporal information associated with each content, the contents conforming to a format, the temporal information including creation time of each content, the thumbnail view including at least two thumbnails representative of first and second contents, the first content being an optional one of the contents, the second content being another of the contents that is temporally next to the first content according to the temporal information. The display apparatus includes a time difference calculator configured to calculate, according to the temporal information of the first and second contents, a time difference between creation time of the first content and creation time of the second content; a correlation value calculator configured to calculate, according to the calculated time difference, a correlation value for the temporal information of the first and second contents; a symbol generator configured to generate a symbol representing the calculated correlation value; a thumbnail generator configured to generate the at least two thumbnails representing the first and second contents; and a display controller configured to display a thumbnail view showing the at least two thumbnails with the generated symbol arranged between the at least two thumbnails.

In order to accomplish the above-mentioned object, a second aspect of the present invention provides a display apparatus having a function of displaying a thumbnail view according to content data and scene data, the content data including at least one content that is based on a predetermine format and is reproducible for a predetermined continuous time, the scene data including temporal information for each of a plurality of scenes extracted from the content, the temporal information including creation time of each scene, the thumbnail view including at least two thumbnails representative of first and second scenes, the first scene being an optional one of the extracted scenes, the second scene being another of the extracted scenes that is temporally next to the first scene according to the temporal information. The display apparatus includes a time difference calculator configured to calculate, according to the temporal information of the first and second scenes, a time difference between creation end time of the first scene and creation start time of the second scene; a correlation value calculator configured to calculate, according to the calculated time difference, a correlation value for the temporal information of the first and second scenes; a symbol generator configured to generate a symbol representing the calculated correlation value; a thumbnail generator configured to generate the at least two thumbnails representing the first and second scenes; and a display controller configured to display a thumbnail view showing the at least two thumbnails with the generated symbol arranged between the at least two thumbnails.

In a preferred embodiment of the present invention, the display controller displays the thumbnail view showing at least three thumbnails spaced uniformly and symbols generated by the symbol generator and arranged between the at least three thumbnails.

In a preferred embodiment of the present invention, the display controller displays the symbol having a spool shape with a center constriction, of which a width becomes longer as the correlation value becomes larger.

In a preferred embodiment of the present invention, the display controller displays the symbol, of which a width becomes longer as the correlation value becomes larger.

In a preferred embodiment of the present invention, the display controller displays the symbol, of which a position from a bottom side of the thumbnails becomes higher as the correlation value becomes larger.

In this way, the present invention can provide a display apparatus capable of displaying a view of thumbnails representing contents so that temporal relationships among the contents are easily understandable.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing a functional configuration of a display apparatus according to a first embodiment of the present invention;

FIG. 2 is a block diagram showing a functional configuration of a differential symbol generator in the display apparatus according to the first embodiment;

FIG. 3 is a view showing an example of a thumbnail view displayed on the display apparatus according to the first embodiment;

FIG. 4 is a flowchart showing a process carried out in the display apparatus according to the first embodiment;

FIG. 5 is a flowchart showing a process carried out in the differential symbol generator of the display apparatus according to the first embodiment;

FIG. 6 is a view showing another thumbnail view displayed on the display apparatus according to the first embodiment;

FIG. 7 is a view showing still another thumbnail view displayed on the display apparatus according to the first embodiment;

FIG. 8 is a view showing still another thumbnail view displayed on the display apparatus according to the first embodiment;

FIG. 9 is a view showing still another thumbnail view displayed on the display apparatus according to the first embodiment;

FIG. 10 is a view showing still another thumbnail view displayed on the display apparatus according to the first embodiment;

FIG. 11 is a view showing still another thumbnail view displayed on the display apparatus according to the first embodiment;

FIG. 12 is a block diagram showing a functional configuration of a display apparatus according to a second embodiment of the present invention;

FIG. 13 is a view showing an example of scene data used in the display apparatus according to the second embodiment;

FIG. 14 is a block diagram showing a functional configuration of a differential symbol generator in the display apparatus according to the second embodiment;

FIG. 15A is a view showing an example of a thumbnail view displayed on the display apparatus according to the second embodiment;

FIG. 15B is a view explaining the thumbnail view of FIG. 15A;

FIG. 16 is a flowchart showing a process carried out in the display apparatus according to the second embodiment; and

FIG. 17 is a flowchart showing a process carried out in the differential symbol generator of the display apparatus according to the second embodiment.

### DETAILED DESCRIPTION OF EMBODIMENTS

### First Embodiment

FIG. 1 shows a display apparatus 1 according to the first embodiment of the present invention. The display apparatus 1 includes an input unit 11, a thumbnail generator 12, a differential symbol generator 13, a thumbnail view generator 14, and a display controller 15. The display apparatus 1 may be installed in a unit having a list-of-content displaying function, such as a digital camera, a video recorder, a video player, or the like. The list-of-content displaying function is a function to display a thumbnail view containing a plurality of thumbnails each representing a content.

The display apparatus 1 includes a storage device 20 that stores content data 21 which contains a plurality of contents. The storage device 20 may be detachable or not detachable with respect to the display apparatus 1. The storage device 20 may be an external device that is connectable to the display apparatus 1 through a transmission path (not shown).

The content data 21 contains a plurality of contents created according to a given format and timestamps, i.e., temporal information associated with the contents. Each timestamp may indicate date and time when the corresponding content was created. The “content” is data of any type, such as still image data, movie data, text data, and audio data. The content may be a combination of different types of data, such as a combination of movie data and audio data. The content data 21 may contain any number of contents. If a content in the content data 21 is still image data or movie data, the content may be created by photographing an object with a camera. If a content in the content data 21 is audio data, the content may be created by recording sounds with a microphone.

The display apparatus 1 may be installed in a video camera. In this case, each content in the content data 21 is one photographed with an image pickup element (not shown) of the video camera. The display apparatus 1 may be installed in a video recorder or a video player. In this case, each content in the content data 21 may be sent through a transmission path (not shown) connected to the outside. In the following explanation, an assumption is made that the storage device 20 stores the content data 21 beforehand.

According to the first embodiment, a timestamp associated with a content is time when the content was created. More precisely, if the content is a still image, the timestamp indicates shooting time. If the content is movie data, the time stamp includes shooting start time and shooting end time, or shooting start time and a total shooting period.

The input unit 11 is an input button, a touch panel, or the like that is used by a user to conduct an operation and select a content.

The thumbnail generator 12 extracts contents from the content data 21 and generates thumbnails representative of the contents. The thumbnails are used when displaying a thumbnail view that allows a user to collectively grasp the contents. Each thumbnail represents a corresponding content and is small relative to a maximum screen size of the display 16. For a content containing still images, the thumbnail generator 12 generates a reduced image of each still image as a thumbnail. For a content containing movies, the thumbnail generator 12 generates a reduced frame of each movie as a thumbnail.

When generating thumbnails from a content that contains still images or movies, the thumbnail generator 12 may calculate a reduction ratio according to the number of thumbnails to be displayed on the display 16 and generate thumbnails by reducing the contents according to the reduction ratio. Instead, a reduction ratio for each number of thumbnails to be displayed on the display 16 may be stored in a memory (not shown) in advance, and the thumbnail generator 12 may select a proper one of the stored reduction ratios and generate thumbnails according to the selected reduction ratio.

In this specification, the thumbnail is a reduced image representing image data, movie data, audio data, or the like that is stored as a content in content data. For a content containing audio data, the thumbnail generator 12 generates, as a thumbnail, a reduced image of a frequency waveform sampled from a portion of the audio data. A graphic figure representing text data, a graphic figure representing audio data, and other graphic figures representing various data formats may be stored in a memory (not shown) beforehand, so that the thumbnail generator 12 may combine a proper one of the graphic figures with an identifier of a given content, to generate a thumbnail.

The differential symbol generator 13 reads contents of the content data 21 from the storage device 20, finds relationships on a time axis of the contents according to timestamps that are associated with the contents and are contained in the content data 21, and generates a differential symbol representing a relationship on a time axis of every two adjacent contents. The “relationship on a time axis” is a relationship of time points when the two adjacent contents were created and indicates a degree of the difference between the time points. The “differential symbol” indicates a relationship on a time axis of two adjacent contents and relates thumbnails representing the two contents to each other. In this specification, the “relationship on a time axis” is referred to as “temporal relationship.”

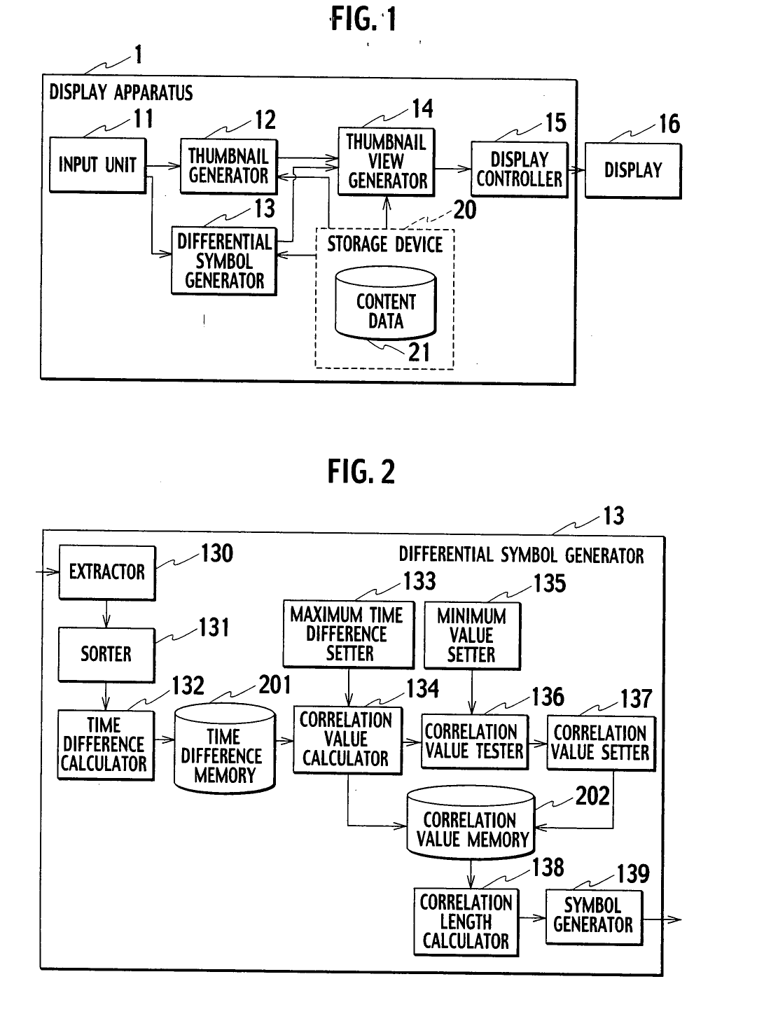

FIG. 2 shows the details of the differential symbol generator 13. The differential symbol generator 13 has an extractor 130, a sorter 131, a time difference calculator 132, a maximum time difference setter 133, a correlation value calculator 134, a minimum value setter 135, a correlation value tester 136, a correlation value setter 137, a correlation length calculator 138, and a symbol generator 139. The differential symbol generator 13 further includes a time difference memory 201 and a correlation value memory 202.

The extractor 130 extracts timestamps associated with contents from the content data 21 read out of the storage device 20.

According to the extracted timestamps, the sorter 131 sorts identifiers of the contents in order of time when the contents were created. The sorter 131 relates the identifier and timestamp of each content to a number assigned to the content sorted in order of time and outputs the number, identifier, and timestamp of each content. If the contents in the content data 21 are sorted in order of time beforehand, the contents can be processed according to the sorted order. In this case, the sorter 131 may be omitted.

According to timestamps associated with first and second contents that are consecutive in order of time, the time difference calculator 132 calculates a relative time difference Td between the two contents. Here, any given content can be the first content, and a content next to the first content in order of time must be the second content. If each content is a still image, the first content is photographed before the second content. In this case, the time difference Td is the difference between time when the first content is photographed and time when the second content is photographed. If each content is movie data, the first content is photographed before the second content. In this case, the time difference Td is the difference between time when the first content is completely photographed and time when the second content is started to be photographed.

The time difference calculator 132 relates the calculated time difference Td to the identifiers of the first and second contents and stores the data in the time difference memory 201.

The maximum time difference setter 133 sets a maximum time difference Tmax used by the correlation value calculator 134 to be explained later. A value set for the maximum time difference Tmax may be preset in a memory (not shown), or may be entered by the user through the input unit 11.

According to the maximum time difference Tmax set by the maximum time difference setter 133 and the time difference Td stored in the time difference memory 201, the correlation value calculator 134 calculates a time difference correlation value Cd indicative of a temporal correlation between the first and second contents. The correlation value calculator 134 relates the calculated time difference correlation value Cd to the identifiers of the first and second contents and stores the data in the correlation value memory 202. The time difference correlation value Cd is calculable as follows:

Cd=1−{Log(Td/k)/Log(Tmax/k)} (1)

where k is a predetermined value, for example, 10.

The time difference Td becomes larger as the difference between the creation time of the first content and the creation time of the second content becomes longer. Consequently, the time difference correlation value Cd becomes smaller as the difference between the creation time of the first content and the creation time of the second content becomes longer. In the following explanation, the difference (distance) between the creation time of the first content and the creation time of the second content is referred to as “time distance.”

The minimum value setter 135 sets a minimum time difference correlation value Cmin used by the correlation value tester 136 to be explained later. A value set for the minimum value Cmin may be preset in a memory (not shown), or may be entered by the user through the input unit 11. The minimum value Cmin is a minimum of the time difference correlation value Cd and is in the range of “0<Cmin≦1.” In the following explanation, the minimum value Cmin is set to 0.1. The minimum value Cmin is used to prevent the time difference correlation value Cd from dropping to a negative value and the negative value from being assigned as the size of a differential symbol.

The correlation value tester 136 checks to see if the time difference correlation value Cd calculated by the correlation value calculator 134 is within the range of “Cmin (0.1)≦Cd≦1.”

According to a result provided by the correlation value tester 136, the correlation value setter 137 rewrites the correlation value stored in the correlation value memory 202 to a new value. More precisely, if the correlation value tester 136 determines that the correlation value Cd is greater than 1, the correlation value setter 137 rewrites the correlation value Cd to 1. If the correlation value tester 136 determines that the correlation value Cd is smaller than Cmin (0.1), the correlation value setter 137 rewrites the correlation value Cd to the minimum value Cmin. If Cmin≦Cd≦1, the correlation value Cd stored in the correlation value memory 202 can be used as it is, and therefore, the correlation value Cd is not rewritten.

According to the time difference correlation value Cd stored in the correlation value memory 202, the correlation length calculator 138 calculates a time difference correlation length Hd used when displaying the temporal relationship of the first and second contents, as follows:

Hd=H×Cd (2)

where H is the length of a side of a thumbnail representing the first (second) content to be connected to a thumbnail representing the second (first) content.

In this way, this embodiment calculates the correlation length Hd with the use of the time difference correlation value Cd calculated based on the maximum time difference Tmax, instead of the relative time difference Td. As a result, the correlation length Hd is obtained as a correlation with respect to the maximum time difference Tmax.

According to the correlation length Hd, the symbol generator 139 generates a differential symbol that relates the thumbnails of the first and second contents to each other. The differential symbol generator 13 outputs the differential symbol generated by the symbol generator 139.

The thumbnail view generator 14 relates the thumbnails generated by the thumbnail generator 12 with the differential symbols generated by the differential symbol generator 13 and generates a thumbnail view.

The display controller 15 displays the thumbnail view generated by the thumbnail view generator 14 on the display 16. The display 16 may be a part of the display apparatus 1, or an external unit connected to the display apparatus 1 through a transmission path.

FIG. 3 shows an example of a thumbnail view displayed on the display 16. The thumbnail view 500 shown in FIG. 3 includes thumbnails 501a to 501i representing still image contents. The thumbnails 501a to 501i are related to each other with differential symbols 502a to 502h. In the thumbnail view 500 of FIG. 3, each differential symbol indicates a temporal relationship of two adjacent thumbnails. Each differential symbol has a spool shape with a center constriction. The spool shape is formed by joining two trapezoids with short sides thereof attached to each other. The other side (long side) of each trapezoid is attached to a side of a thumbnail. In each trapezoid, a long side attached to a thumbnail has a length H (mentioned in the expression (2)) and a short side attached to the other trapezoid has a length Hd (mentioned in the expression (2)). The length Hd is the correlation length Hd calculated by the correlation length calculator 138.

In the thumbnail view 500 of FIG. 3, the thumbnails 501a and 501b of the contents 1 and 2 are related to each other with the first differential symbol 502a. The thumbnails 501b and 501c of the contents 2 and 3 are related to each other with these second differential symbol 502b. From the thumbnail view 500 in which the thumbnails 500a to 500i are arranged in order of 500a to 500i, it is understood that the contents 1 to 9 were photographed in order of 1 to 9.

The first and second differential symbols 502a and 502b have different constrictions. A wider constriction corresponds to a larger time difference correlation value Cd, i.e., a shorter time distance. A narrower constriction corresponds to a smaller time difference correlation value Cd, i.e., a longer time distance. In the thumbnail view 500 of FIG. 3, a time distance between the contents 1 and 2 is longer than that between the contents 2 and 3.

In the thumbnail view 500 of FIG. 3, the thumbnails are arranged in three rows. The top row includes the thumbnails of the contents 1 to 3, the middle row includes the thumbnails of the contents 4 to 6, and the bottom row includes the thumbnails of the contents 7 to 9. Between two adjacent rows, the thumbnail view generator 14 relates tail and head contents to each other with a differential symbol divided into two. More precisely, to relate the thumbnails 501c and 501d of the contents 3 and 4 to each other, the thumbnail view generator 14 divides a differential symbol at the center into differential symbols 502c and 502c′ and attaches the differential symbol 502c to the thumbnail 501c and the differential symbol 502c′ to the thumbnail 501d.

The thumbnail view 500 has a numeral window 503 showing “ 1/10” in FIG. 3. The numeral “ 1/10” means that the contents contained in the content data 21 are divided into 10 groups when thumbnails of the contents are displayed in the thumbnail view 500 nine by nine and that the contents presently displayed in the thumbnail view 500 are of the group 1.

The user can manipulate the input unit 11 to enter a request to display the next group or a request to display the preceding group. Also, the user can select an optional one of the thumbnails in the thumbnail view 500 and enter an enlargement request to display an enlarged image of the selected thumbnail on the display 16.

For example, in the thumbnail view 500, the user may manipulate the input unit 11 to enter a request to display the next group of contents. Then, the second group of contents will be displayed with corresponding thumbnails and differential symbols. At this time, the numeral window 503 shows “ 2/10” in place of “ 1/10.” In the thumbnail view 500, the thumbnail 501d representing the content 4 is surrounded with a thick frame to indicate that the content 4 is in a selected state. If an enlargement request is entered under this state, an enlarged view of the content 4 is displayed on the display 16.

<<Overall Flow of Operation>>

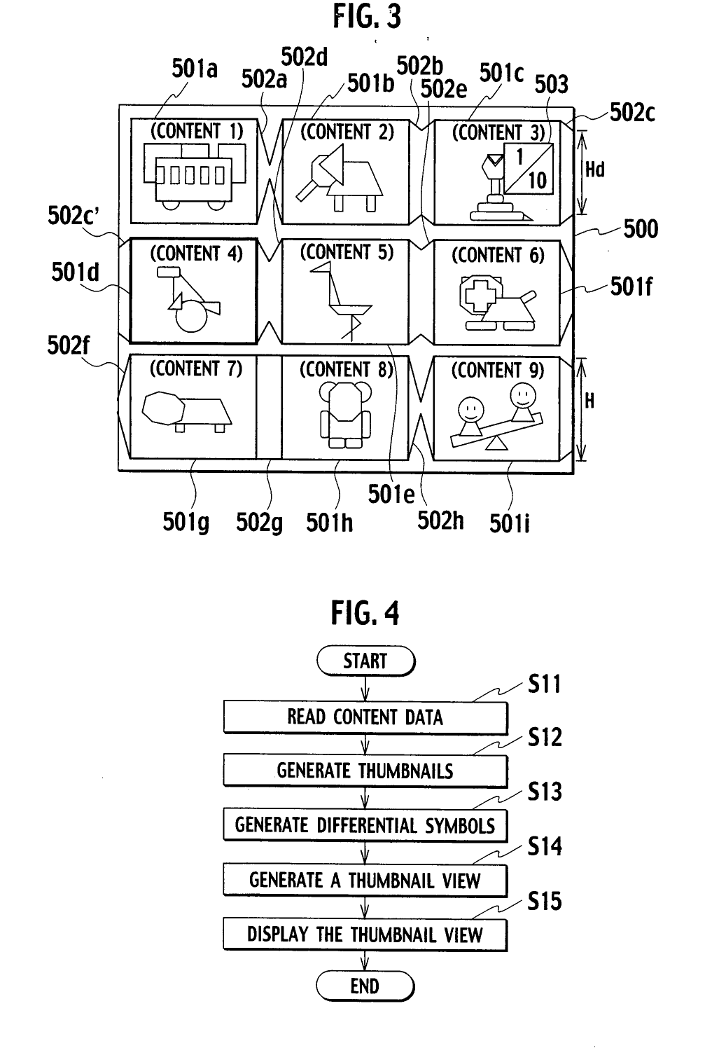

With reference to a flowchart shown in FIG. 4, an example of a displaying process carried out with the display apparatus 1 will be explained. The displaying process starts when the user enters a display request through the input unit 11. In step S11, the thumbnail generator 12 and differential symbol generator 13 read the content data 21 out of the storage device 20.

In step S12, the thumbnail generator 12 generates a thumbnail for each content contained in the content data 21.

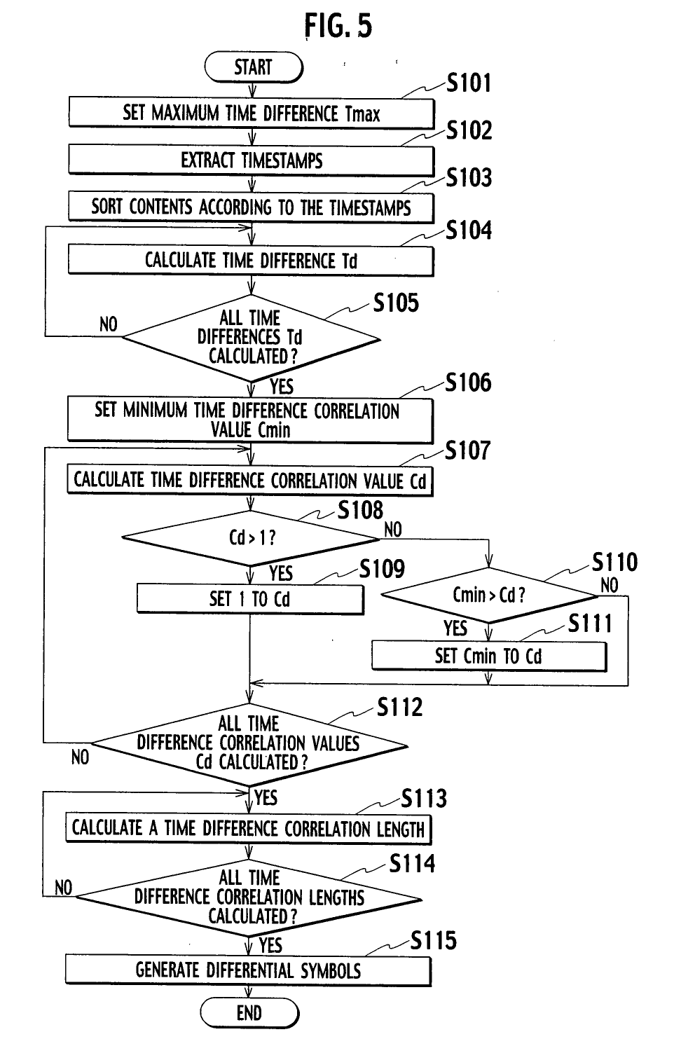

In step S13, the differential symbol generator 13 generates, according to timestamps contained in the content data 21 and associated with the contents, differential symbols each of which relates two temporally adjacent thumbnails to each other. For convenience of explanation, any given content is referred to as a first content and a content that is temporally next to the first content is referred to as a second content. The details of the differential symbol generating process carried out in the differential symbol generator 13 will be explained later with reference to a flowchart shown in FIG. 5.

In step S14, the thumbnail view generator 14 generates a thumbnail view in which the first and second contents are related to each other with the differential symbol specific to them. In step S15, the display controller 15 displays the thumbnail view on the display 16.

When generating a thumbnail view, all contents of the content data 21 are not always included in the thumbnail view. It is sufficient to process at least a group of contents to be displayed on the display 16, timestamps associated with these contents, a timestamp associated with a content that precedes the group, and a timestamp associated with a content that follows the group. Limiting the contents to be processed in this way may shorten a total process time. In the example of the thumbnail view 500 shown in FIG. 3, it is necessary to read and process the contents 1 to 9, timestamps associated with the contents 1 to 9, and timestamps associated with contents that are just in front of and just behind the contents 1 to 9. In this example, there is no content in front of the content 1, and therefore, a timestamp associated with a content that is next to the content 9 is read when generating the thumbnail view 500.

<<Differential Symbol Generation>>

With reference to the flowchart shown in FIG. 5, the differential symbol generating process carried out by the differential symbol generator 13 in step S13 of FIG. 4 will be explained. When the differential symbol generating process starts, the maximum time difference setter 133 sets a maximum time difference Tmax in step S101.

In step S102, the extractor 130 extracts timestamps associated with the contents from the content data 21 that has been read out of the storage device 20.

In step S103, the sorter 131 sorts, according to the extracted timestamps, identifiers of the contents in order of time and stores the sorted data in a memory (not shown).

In step S104, the time difference calculator 132 calculates a relative time difference Td between two temporally adjacent contents and stores the time difference Td in the time difference memory 201. The time difference calculator 132 repeats the calculation in step S104 until a time difference Td is calculated for every adjacent contents, i.e., until step S105 provides YES.

In step S106, the minimum value setter 135 sets a minimum time difference correlation value Cmin.

In step S107, the correlation value calculator 134 calculates a time difference correlation value Cd according to the time difference Td calculated by the time difference calculator 132 and stored in the time difference memory 201 in step S104 and the maximum time difference Tmax set by the maximum time difference setter 133 in step S101.

In step S108, the correlation value tester 136 checks to see if the time difference correlation value Cd is greater than 1. If the value Cd is greater than 1 (YES in step S108), the correlation value setter 137 rewrites, in step S109, the value Cd in question in the correlation value memory 202 to 1. If the value is not greater than 1 (NO in step S108), the correlation value tester 136 checks in step S110 to see if the value Cd is smaller than the minimum value Cmin. If the value Cd is smaller than the minimum value Cmin (YES in step S110), the correlation value setter 137 rewrites, in step S111, the value Cd in question in the correlation value memory 202 to the minimum value Cmin.

If all time difference correlation values Cd have been calculated and processed through steps S107 to S111, i.e., if step S112 provides YES, the correlation length calculator 138 calculates a time difference correlation length Hd for each time difference correlation value Cd in step S113.

After the correlation length calculator 138 calculates the correlation length Hd for every time difference correlation value Cd, step S114 provides YES. Then, in step S115, the symbol generator 139 generates differential symbols according to the calculated time difference correlation lengths Hd, and the differential symbol generating process ends.

In this way, the first embodiment relates thumbnails representing a plurality of contents to each other with differential symbols that differ depending on time differences, to thereby allow a user to easily grasp temporal relationships of the contents along a time axis.

### <Examples of Thumbnail View>

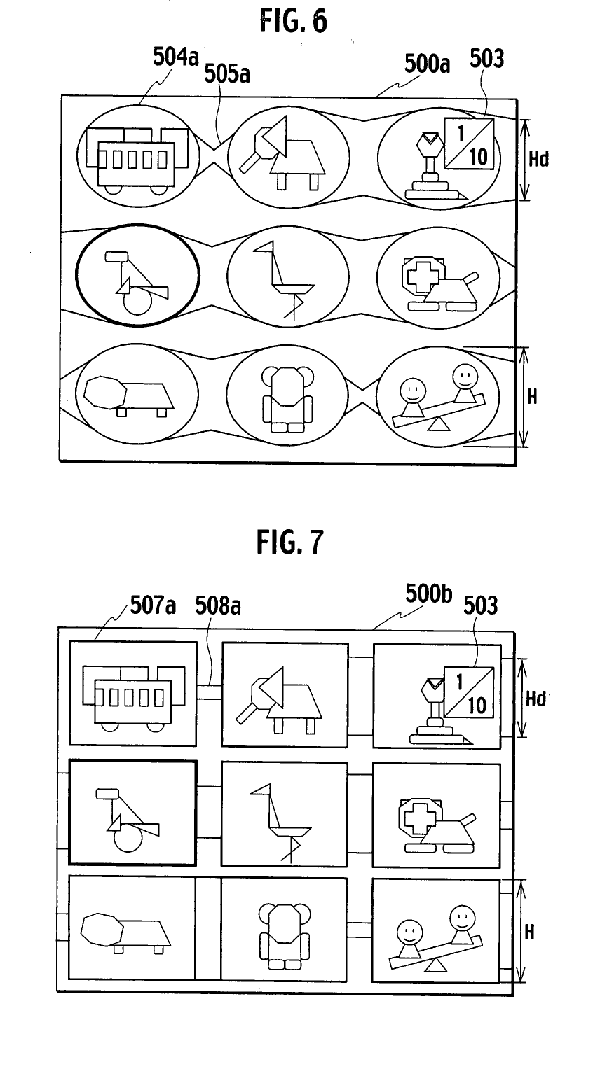

The thumbnail view generator 14 may generate, other than the thumbnail view 500 shown in FIG. 3, any thumbnail view that temporally relates thumbnails representing contents to each other with the use of differential symbols. FIGS. 6 to 11 show examples of such thumbnail views.

In a thumbnail view 500a shown in FIG. 6, each thumbnail 504a is elliptic. The elliptic thumbnail 504a allows a user to easily recognize a differential symbol 505a and quickly grasp a temporal relationship between contents. The differential symbol 505a has a spool shape like the differential symbols 502a to 502h shown in FIG. 3 with the width of a constriction of the differential symbol indicating a temporal relationship between contents. The width of a constriction of a given differential symbol 505a corresponds to a time difference correlation length Hd calculated by the correlation length calculator 138 according to the expression (2) in which H is a vertical length of the thumbnail 504a.

In a thumbnail view 500b shown in FIG. 7, each differential symbol 508a has no constriction. Instead, the width itself of the differential symbol 508a indicates a temporal relationship between adjacent contents. The width of the differential symbol 508a corresponds to a time difference correlation length Hd calculated by the correlation length calculator 138 according to the expression (2) in which H is a vertical length of a thumbnail 507a. Accordingly, in the thumbnail view 500b, the wider the width of the differential symbol 508a, the shorter a time distance between the corresponding contents.

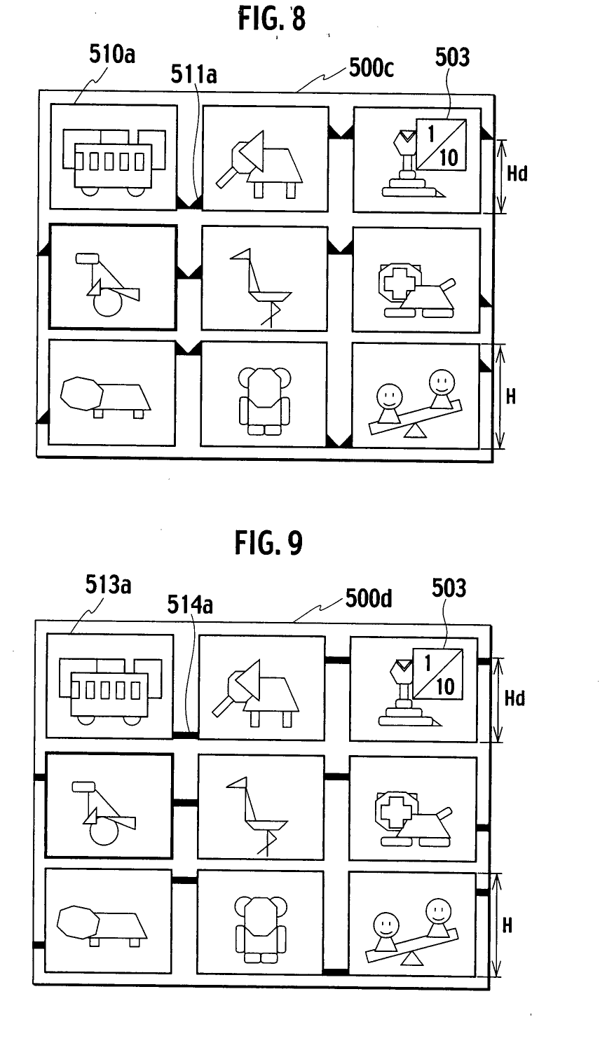

In a thumbnail view 500c shown in FIG. 8, the position of a differential symbol 511a indicates a temporal relationship between adjacent contents. The position of the differential symbol 511a corresponds to a time difference correlation length Hd calculated by the correlation length calculator 138 according to the expression (2) in which H is a vertical length of a thumbnail 510a with a bottom side of the thumbnail 510a being a start point of the length Hd. Accordingly, in the thumbnail view 500c, the higher the position of the differential symbol 511a from the bottom side of the thumbnail 510a, the shorter a time distance between the corresponding contents.

In a thumbnail view 500d shown in FIG. 9, the position of a differential symbol 514a indicates a temporal relationship between adjacent contents. Like the example of FIG. 8, the position of the differential symbol 514a corresponds to a time difference correlation length Hd calculated by the correlation length calculator 138 according to the expression (2) in which H is a vertical length of a thumbnail 513a with a bottom side of the thumbnail 513a being a start point of the length Hd.

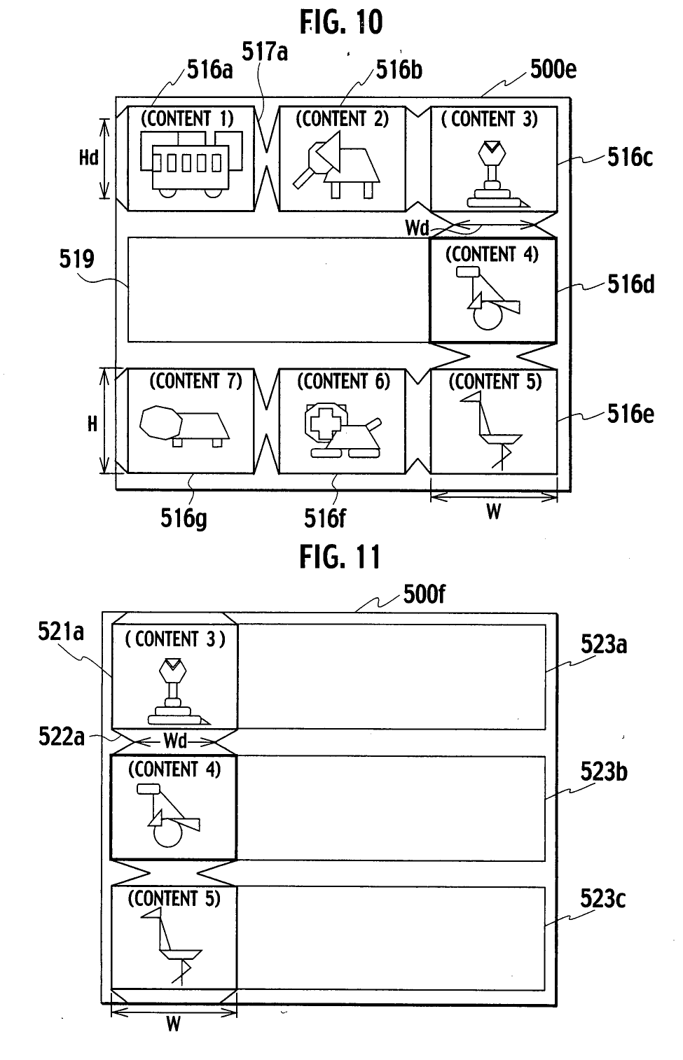

In the examples of FIGS. 3 and 6 to 9, each thumbnail view shows nine thumbnails. The present invention is not limited to these examples. Any number of thumbnails can be shown in a thumbnail view. For example, an embodiment of the present invention allows a thumbnail view 500e shown in FIG. 10. In the thumbnail view 500e, thumbnails 516a to 516g are arranged time series in a laid U-shape from an upper left position to a right end position to a lower left position. Every adjacent thumbnails are related to each other with a differential symbol. Each of the differential symbols 517a to 517f has a spool shape with a center constriction like that of FIG. 3 and is positioned to connect adjacent thumbnails to each other. When adjacent thumbnails are horizontally connected to each other with their vertical sides serving as joint sides, the width of the constriction of the differential symbol is equal to a time difference correlation length Hd calculated according to the expression (2) in which H is a vertical length of the thumbnails. When the adjacent thumbnails are vertically connected to each other with their horizontal sides serving as joint sides, the width of the constriction of the differential symbol is equal to a length Wd calculated according to the following expression (3) in which W is a horizontal length of the thumbnails:

Wd=W×Cd (3)

When the thumbnail view generator 14 generates the thumbnail view 500e shown in FIG. 10, the correlation length calculator 138 calculates a time difference correlation length Hd and a time difference correlation length Wd. For example, the thumbnail 516a representing the content 1 and the thumbnail 516b representing the content 2 are horizontally connected to each other with their vertical sides being joint sides. Accordingly, the width of the constriction of the differential symbol 517a is equal to a time difference correlation length Hd calculated according to a vertical length of the thumbnail 516a (516b). On the other hand, the thumbnail 516c representing the content 3 and the thumbnail 516d representing the content 4 are vertically connected to each other with their horizontal sides being joint sides. In this case, the width of the constriction of the differential symbol 517c is equal to a time difference correlation length wd calculated according to a horizontal length of the thumbnail 516c (516d).

The thumbnail view 500e shown in FIG. 10 has an information window 519 related to the thumbnail view 516d representing the content 4. The information window 519 displays information concerning the related content (the content 4 in FIG. 10). If the content is a still image, the information concerning the content may include shooting date and time, a content name, an image encoding format, a content size, and the like. If the content is audio data, the information concerning the content may include recording date and time, a content name, an audio encoding format, a content size, and the like.

An embodiment of the present invention allows a thumbnail view 500f shown in FIG. 11. In the thumbnail view 500f, thumbnails 521a to 521c are vertically arranged, and information windows 523a to 523c are related to the thumbnails 521a to 521c, respectively, to display information concerning the contents represented with the thumbnails. In this example, the thumbnails are vertically connected to each other with their horizontal sides serving as joint sides, and therefore, the width of a constriction of each of differential symbols 522a and 522b is equal to a time difference correlation length Wd calculated according to the expression (3).

It is to be noted that, although the thumbnails are spaced apparently at regular intervals in FIGS. 3, 6-11, it is not necessary to space them at regular intervals and it is enough if they are spaced at each interval independent upon each time interval. On the other hand, when they are spaced at regular intervals, there is an advantage that the thumbnails are properly perceived and it is easy to recognize the differences of the constriction widths of the differential symbols. Also, there is a further advantage that the maximum number of thumbnails can be included on one screen when they are spaced at regular and minimum intervals so long as they are properly perceived.

### Second Embodiment

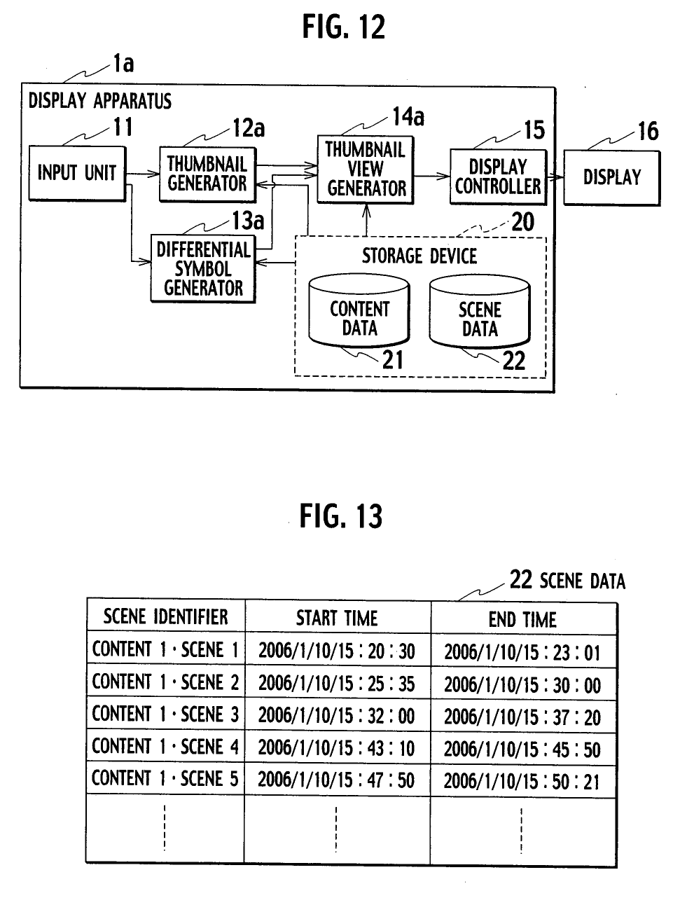

FIG. 12 shows a display apparatus 1a according to the second embodiment of the present invention. The display apparatus 1a includes an input unit 11, a thumbnail generator 12a, a differential symbol generator 13a, a thumbnail view generator 14a, and a display controller 15. In addition, the display apparatus 1a has a storage device 20 for storing content data 21 and scene data 22 containing contents and temporal information, i.e., timestamps. The display apparatus 1a of the second embodiment differs from the display apparatus 1 of the first embodiment in that the storage device 20 additionally stores the scene data 22. Also, function of the thumbnail generator 12a partly differs from that of the thumbnail generator 12, function of the differential symbol generator 13a partly differs from that of the differential symbol generator 13, and function of the thumbnail view generator 14a partly differs from that of the thumbnail view generator 14.

A content containing movie data or audio data is frequently continuous for a long time. From such a long content, several scenes may be extracted to create a digest. The display apparatus 1a according to the second embodiment displays temporal relationships of the scenes of such a digest. A content contained in the content data 21 according to the second embodiment is a content created according to a given format and being continuous for a long time.

FIG. 13 shows an example of the scene data 22. The scene data 22 includes scene identifiers and timestamps. Each scene identifier identifies one of a plurality of scenes of a movie content contained in the content data 21. Each timestamp is temporal information related to a corresponding scene. In the example of FIG. 13, each scene has two timestamps indicating start time and end time. Instead of the end time, a total time of the scene may be used. The “scene” is partial data of a movie content. The “start time” is the time when the creation (shooting, in the case of movie data) of the scene started. The “end time” is the time when the creation of the scene ended. In the example of FIG. 13, the shooting of a scene 1 of a content 1 was started at 15:20:30 on Jan. 10, 2006 and ended at 15:23:01 on the same day.

The thumbnail generator 12a extracts each scene from the content data 21 according to the scene data 22 and generates a thumbnail representing the extracted scene. The extracted thumbnails are used when displaying a thumbnail view of the scenes. Each thumbnail represents a corresponding one of the scenes and is small relative to a maximum size displayable on the display 16. More precisely, the thumbnail generator 12a extracts a scene from the content data 21, forms a reduced image of a frame of the scene, and uses the reduced image as a thumbnail representing the scene. When generating thumbnails, the thumbnail generator 12a may calculate a reduction ratio according to the number of thumbnails to be displayed on the display 16 and generate a thumbnail by reducing an image of a frame sampled from a given scene according to the reduction ratio. Instead, a reduction ratio for each number of thumbnails to be displayed on the display 16 may be stored in a memory (not shown) in advance, and the thumbnail generator 12a may select a proper one of the stored reduction ratios and generate a thumbnail by reducing an image of a frame sampled from a given scene according to the selected reduction ratio. For a content containing audio data, the thumbnail generator 12a generates, as a thumbnail, a reduced image of a frequency waveform sampled from a portion of the audio data. A graphic figure representing text data or audio data may be defined and stored in a memory (not shown) beforehand, so that the thumbnail generator 12a may combine one of the graphic figures with an identifier of a content, to generate a thumbnail for the content. Graphic figures representing various data formats such as audio data formats may be stored in a memory (not shown) beforehand, so that the thumbnail generator 12a may combine one of the graphic figures with an identifier of a content, to generate a thumbnail for the content.

The differential symbol generator 13a reads the scene data 22 from the storage device 20, finds a temporal relationship of every adjacent scenes according to timestamps that are associated with the scenes and are contained in the scene data 22, and generates a differential symbol representing the temporal relationship of the adjacent scenes. The “temporal relationship” of two adjacent scenes is a relationship on a time axis of time points at which the two adjacent scenes were created and indicates a degree of the difference between the time points. The “differential symbol” has a specific shape or position to indicate a temporal relationship of two adjacent scenes and relates thumbnails representing the two adjacent scenes to each other.

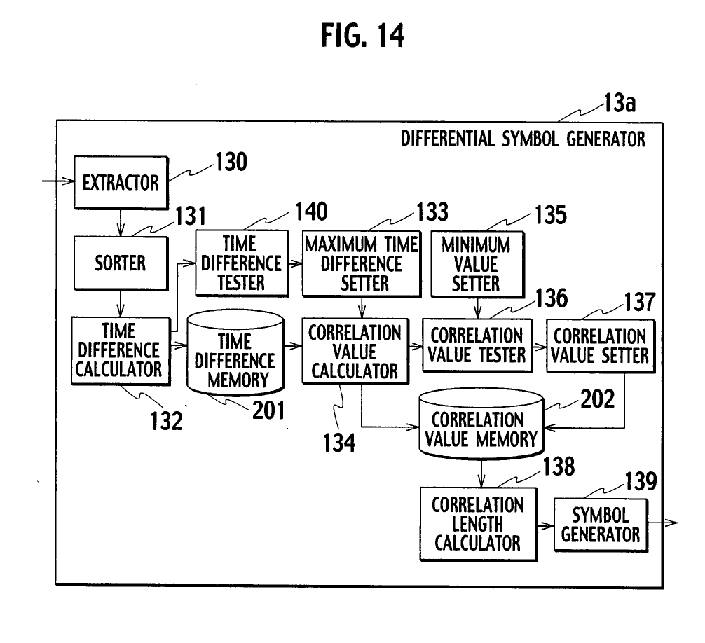

FIG. 14 shows the details of the differential symbol generator 13a. The differential symbol generator 13a has an extractor 130, a sorter 131, a time difference calculator 132, a maximum time difference setter 133, a correlation value calculator 134, a minimum value setter 135, a correlation value tester 136, a correlation value setter 137, a correlation length calculator 138, a symbol generator 139, and a time difference tester 140. The differential symbol generator 13a further includes a time difference memory 201 and a correlation value memory 202. The differential symbol generator 13a differs from the differential symbol generator 13 explained with reference to FIG. 2 in that it additionally has the time difference tester 140. The components 130 to 139 of FIG. 2 execute a process of generating a differential symbol representing a content-to-content temporal relationship. Instead, the components of FIG. 14 execute a process of displaying a differential symbol representing a scene-to-scene temporal relationship. This difference will be explained.

The extractor 130 extracts timestamps associated with identifiers of scenes from the scene data 22 read out of the storage device 20.

According to the extracted timestamps, the sorter 131 sorts the identifiers of scenes in order of time points at which the scenes were created. The sorter 131 relates the identifier and timestamps of each scene to a number assigned to the scene sorted in order of time and outputs the number, identifier, and timestamps of each scene. If the scenes are sorted in order of time beforehand with the use of the scene data 22 of FIG. 13, the scenes can be processed as they are without re-sorting them. In this case, the sorter 131 may be omitted.

According to timestamps associated with first and second scenes that are consecutive in order of time, the time difference calculator 132 calculates a relative time difference Td between the two scenes. Here, any given scene can be the first scene, and a scene next to the first scene in order of time must be the second scene. If each scene is a part of a movie content, the first scene is photographed before the second scene. In a digest produced from a movie content, the first and second scenes are consecutive. In this case, the time difference Td is the difference between time when the shooting of the first scene is completed and time when the shooting of the second scene is started. If the scene data 22 stores a “total time” of each scene instead of the “end time” of the scene, the time difference calculator 132 finds end time from the start time and total time and calculates the time difference Td.

The time difference calculator 132 relates the calculated time difference Td to the identifiers of the first and second scenes and stores the data in the time difference memory 201.

The time difference tester 140 compares the time difference Td just calculated with a preceding time difference Td and determines a larger one of them.

The maximum time difference setter 133 sets a maximum time difference Td determined by the time difference tester 140 as a maximum time difference Tmax used by the correlation value calculator 134 to be explained later.

According to the maximum time difference Tmax set by the maximum time difference setter 133 and the time difference Td stored in the time difference memory 201, the correlation value calculator 134 calculates a time difference correlation value Cd indicative of a temporal correlation between the first and second scenes. The correlation value calculator 134 relates the calculated time difference correlation value Cd to the identifiers of the first and second scenes and stores the data in the correlation value memory 202. The time difference correlation value Cd is calculable as follows:

Cd=1−{Log(Td/k)/Log(Tmax/k)} (4)

where k is a predetermined value, for example, 10.

The time difference Td becomes larger as the difference between the creation time of the first scene and the creation time of the second scene becomes longer. Consequently, the time difference correlation value Cd becomes smaller as the difference between the creation time of the first scene and the creation time of the second scene becomes longer. In the following explanation, the difference (distance) between the creation time of the first scene and the creation time of the second scene is referred to as “time distance.”

The minimum value setter 135 sets a minimum time difference correlation value Cmin used by the correlation value tester 136 to be explained later. A value set for the minimum value Cmin may be preset in a memory (not shown), or may be entered by the user through the input unit 11. The minimum value Cmin is a minimum of the time difference correlation value Cd and is in the range of “0<Cmin≦1.” In the following explanation, the minimum value Cmin is set to 0.1. The minimum value Cmin is used to prevent the time difference correlation value Cd from dropping to a negative value and the negative value from being assigned as the size of a differential symbol.

The correlation value tester 136 checks to see if the time difference correlation value Cd calculated by the correlation value calculator 134 is within the range of “Cmin (0.1)≦Cd≦1.”

According to a result provided by the correlation value tester 136, the correlation value setter 137 rewrites the correlation value in question stored in the correlation value memory 202 to a new value. More precisely, if the correlation value tester 136 determines that the correlation value Cd is greater than 1, the correlation value setter 137 rewrites the correlation value Cd to 1. If the correlation value tester 136 determines that the correlation value Cd is smaller than Cmin (0.1), the correlation value setter 137 rewrites the correlation value Cd to the minimum value Cmin (0.1). If Cmin≦=Cd≦1, the correlation value Cd stored in the correlation value memory 202 can be used as it is, and therefore, the correlation value Cd is not rewritten.

According to the time difference correlation value Cd stored in the correlation value memory 202, the correlation length calculator 138 calculates a time difference correlation length Wd used when displaying the temporal relationship of the first and second scenes, as follows:

Wd=W×Cd (5)

where W is the length of a side of a thumbnail representing the first (second) scene to be connected to a thumbnail representing the second (first) scene.

In this way, this embodiment calculates a correlation length Wd with the use of the time difference correlation value Cd calculated based on the maximum time difference Tmax, instead of the relative time difference Td. As a result, the correlation length Wd is obtained as a correlation with respect to the maximum time difference Tmax.

According to the correlation length Wd, the symbol generator 139 generates a differential symbol that relates the thumbnails of the first and second scenes to each other. The differential symbol generator 13a outputs the differential symbol generated by the symbol generator 139.

The input unit 11, display controller 15, and display 16 have substantially the same functions as those of the first embodiment, and therefore, their explanations are omitted.

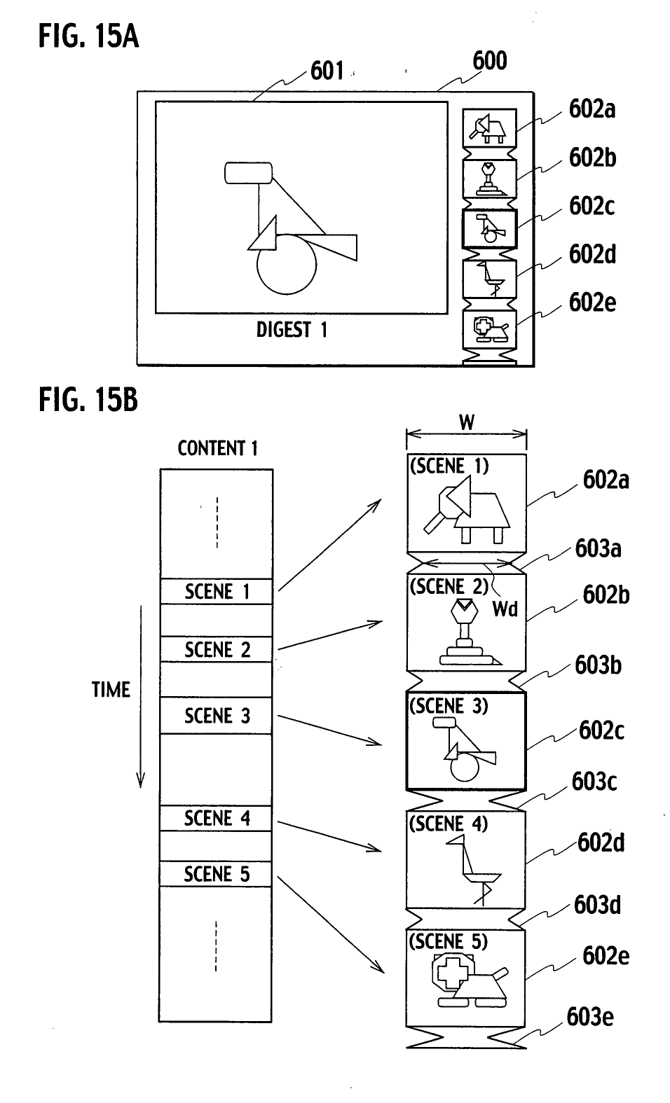

FIGS. 15A and 15B show an example of a thumbnail view displayed on the display 16 according to the second embodiment. In FIG. 15A, the thumbnail view 600 shows thumbnails 602a to 602e representing five scenes extracted from a content. The five scenes form a digest. Every two adjacent ones of the thumbnails 602a to 602e are related to each other with a differential symbol that indicates a temporal relationship of the scenes represented with the thumbnails. FIG. 15B shows the thumbnails 602a to 602e, differential symbols associated with these thumbnails, and scenes 1 to 5 extracted from a content and represented with the thumbnails. Like the first embodiment, each of the differential symbols 603a to 603d has a spool shape with a center constriction.

The scenes 1 to 5 extracted from the content 1 form a digest 1. From the scenes 1 to 5, the thumbnails 602a to 602e are generated and included in the thumbnail view 600 that is displayed on the display 16.

In FIG. 15B, the thumbnails 602b and 602c representing the scenes 2 and 3 are related to each other with the first differential symbol 603b, the thumbnails 602c and 602d representing the scenes 3 and 4 are related to each other with the second differential symbol 603c, and so on. The second and third differential symbols 603b and 603c have constrictions of different lengths. A wider constriction corresponds to a shorter time distance, and a narrower constriction corresponds to a longer time distance. Namely, one can recognize from the symbols 603b and 603c that the time distance between the scenes 2 and 3 is shorter than that between the scenes 3 and 4.

In FIG. 15B, the thumbnail 602e representing the scene 5 is related to the differential symbol 603e to indicate that another scene follows the scene 5. In this case, the user can manipulate the input unit 11 to enter a request for displaying the next scene. In the thumbnail view 600, the thumbnail 602c representing the scene 3 is surrounded with a thick frame to indicate that the scene 3 is selected. The selected scene is displayed in an enlarged size in a display window 601 shown in FIG. 15A. If the user enters a reproduction request through the input unit 11, the digest 1 is reproduced from the scene 3 in the display window 601.

<<Overall Flow of Operation>>

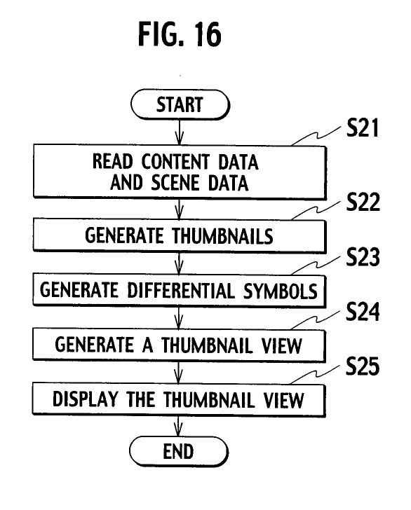

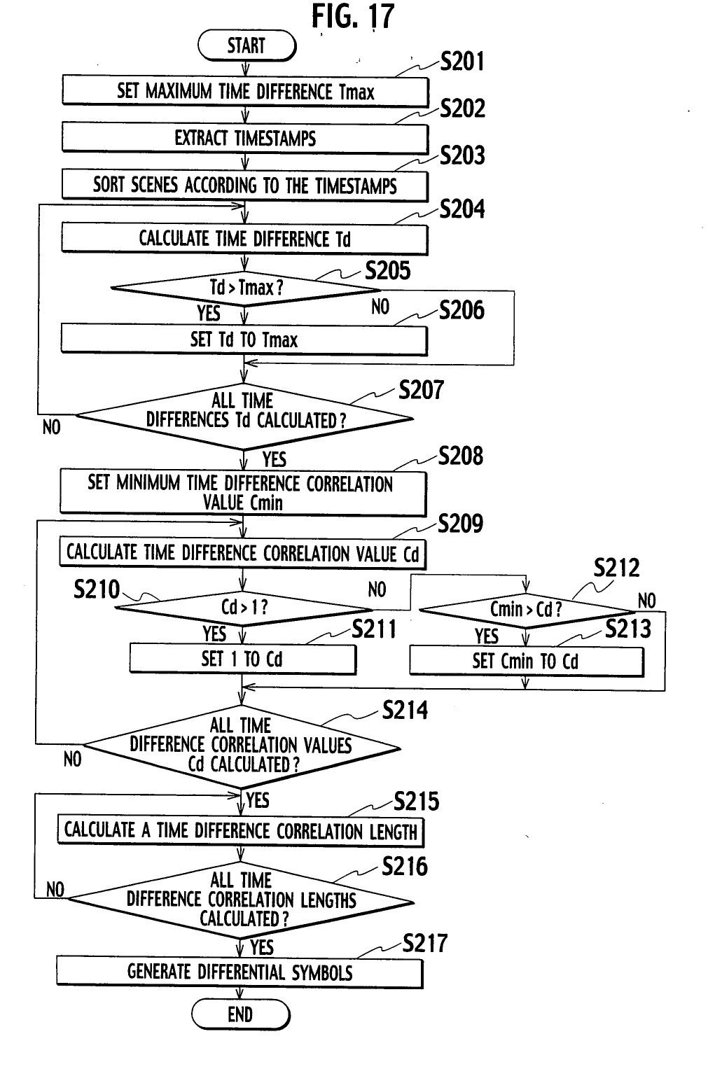

With reference to a flowchart shown in FIG. 16, an example of a displaying process carried out with the display apparatus 1a will be explained. The displaying process starts when the user enters a display request through the input unit 11 of the display apparatus 1a. In step S21, the thumbnail generator 12a and differential symbol generator 13a read the content data 21 and scene data 22 out of the storage device 20.

In step S22, the thumbnail generator 12a extracts from the read content data 21 each scene specified by the scene data 22, generates a thumbnail for each extracted scene, and stores the generated thumbnails for the scenes in a memory (not shown). If the read scene data 22 is like that shown in FIG. 13, the thumbnail generator 12a extracts, based on the scene data 22, one frame from each of the scenes 1 to 5 and the like out of the content data 21 and generates a thumbnail from the extracted frame.

In step S23, the differential symbol generator 13a generates, according to timestamps contained in the scene data 22, differential symbols each of which relates two temporally adjacent thumbnails to each other. For convenience of explanation, any given scene is referred to as a first scene and a scene that is temporally next to the first scene is referred to as a second scene. The details of the differential symbol generating process carried out in the differential symbol generator 13a will be explained later with reference to a flowchart shown in FIG. 17.

In step S24, the thumbnail view generator 14a generates a thumbnail view in which the first and second scenes are related to each other with the differential symbol specific to them. In step S25, the display controller 15 displays the thumbnail view on the display 16.

<<Differential Symbol Generation>>

With reference to the flowchart shown in FIG. 17, the differential symbol generating process carried out by the differential symbol generator 13a in step S23 of FIG. 16 will be explained. When the differential symbol generating process starts, the maximum time difference setter 133 sets a maximum time difference Tmax to 0 in step S201.

In step S202, the extractor 130 extracts timestamps associated with the identifiers of the scenes from the scene data 22 read out of the storage device 20.

In step S203, the sorter 131 sorts, according to the extracted timestamps, the identifiers of the scenes in order of time and stores the sorted data in a memory (not shown).

In step S204, the time difference calculator 132 calculates a relative time difference Td between two temporally adjacent scenes and stores the time difference Td in the time difference memory 201.

In step S205, the time difference tester 140 determines whether or not Td>Tmax. If Td>Tmax, i.e., if YES in step S205, the maximum time difference setter 133 sets the time difference Td to the maximum time difference Tmax in step S206. Namely, if the newly calculated time difference Td is greater than the maximum time difference Tmax, the time difference Td is set as the maximum time difference Tmax, so that a maximum one of the time differences Td is set as the maximum time difference Tmax.

Once the time difference Td is calculated for every adjacent scenes and the maximum time difference Tmax is set, step S207 provides YES. Then, the minimum value setter 135 sets a minimum time difference correlation value Cmin in step S208.

In step S209, the correlation value calculator 134 calculates a time difference correlation value Cd according to the time difference Td calculated by the time difference calculator 132 and stores the result in the correlation value memory 202.

In step S210, the correlation value tester 136 checks to see if the time difference correlation value Cd is greater than 1. If the value Cd is greater than 1 (YES in step S210), the correlation value setter 137 rewrites, in step S211, the value Cd in question in the correlation value memory 202 to 1. If the value is not greater than 1 (NO in step S210), the correlation value tester 136 checks in step S212 to see if the value Cd is smaller than the minimum value Cmin. If the value Cd is smaller than the minimum value Cmin (YES in step S212), the correlation value setter 137 rewrites, in step S213, the value Cd in question in the correlation value memory 202 to the minimum value Cmin.

If all time difference correlation values Cd have been calculated and tested through steps S209 to S213, i.e., if step S214 provides YES, the correlation length calculator 138 calculates in step S215 a time difference correlation length Wd for each time difference correlation value Cd.

After the correlation length calculator 138 calculates a correlation length Wd for every time difference correlation value Cd, step S216 provides YES. Then, in step S217, the symbol generator 139 generates differential symbols according to the calculated time difference correlation lengths Wd, and the differential symbol generating process ends.

In this way, the second embodiment generates thumbnails representing a plurality of scenes contained in a digest and relates every two adjacent ones of the thumbnails to each other with a differential symbol that differs its shape depending on a time distance between the two thumbnails. The differential symbol allows a user to easily grasp a temporal relationship of the adjacent scenes.

The thumbnail view shown in FIGS. 15A and 15B does not limit the present invention. Thumbnail views according to the present invention can employ various forms of differential symbols for temporally relating thumbnails that represent scenes to each other. For example, it is possible to use differential symbols that employ different positions, instead of different shapes, to indicate temporal relationships of thumbnails. It is also possible to employ elliptic thumbnails instead of quadrangle thumbnails. The various modified examples of thumbnail views, thumbnails, and differential symbols of the first embodiment are also applicable to the second and other embodiments of the present invention.

It is to be noted that, like the first embodiment, although the thumbnails are spaced apparently at regular intervals in FIG. 15, it is not necessary to space them at regular intervals and it is enough if they are spaced at each interval independent upon each time interval. On the other hand, when they are spaced at regular intervals, there is an advantage that the thumbnails are properly perceived and it is easy to recognize the differences of the constriction widths of the differential symbols. Also, there is a further advantage that the maximum number of thumbnails can be included on one screen when they are spaced at regular and minimum intervals so long as they are properly perceived.

Various modifications and alterations of the above-mentioned embodiments of the present invention will occur to those skilled in the art without departing from the scope and spirit of the present invention. It is understood that such modifications and alterations also fall in the scope of the present invention. The scope of the present invention is defined only by the appended claims in reasonable consideration of this specification.

What is claimed is:

1. A display apparatus having a function of displaying a thumbnail view according to content data, the content data including a plurality of contents and temporal information associated with each content, the contents conforming to a format, the temporal information including creation time of each content, the thumbnail view including at least two thumbnails representative of first and second contents, the first content being an optional one of the contents, the second content being another of the contents that is temporally next to the first content according to the temporal information, the apparatus comprising:
a time difference calculator configured to calculate, according to the temporal information of the first and second contents, a time difference between creation time of the first content and creation time of the second content;
a correlation value calculator configured to calculate, according to the calculated time difference, a correlation value for the temporal information of the first and second contents;
a symbol generator configured to generate a symbol representing the calculated correlation value;
a thumbnail generator configured to generate the at least two thumbnails representing the first and second contents; and
a display controller configured to display a thumbnail view showing the at least two thumbnails with the generated symbol arranged between the at least two thumbnails.

2. The display apparatus according to claim 1, wherein the display controller displays the thumbnail view showing at least three thumbnails spaced uniformly and symbols generated by the symbol generator and arranged between the at least three thumbnails.

3. The display apparatus according to claim 1, wherein the display controller displays the symbol having a spool shape with a center constriction, of which a width becomes longer as the correlation value becomes larger.

4. The display apparatus according to claim 1, wherein the display controller displays the symbol, of which a width becomes longer as the correlation value becomes larger.

5. The display apparatus according to claim 1, wherein the display controller displays the symbol, of which a position from a bottom side of the thumbnails becomes higher as the correlation value becomes larger.

6. A display apparatus having a function of displaying a thumbnail view according to content data and scene data, the content data including at least one content that is based on a predetermine format and is reproducible for a predetermined continuous time, the scene data including temporal information for each of a plurality of scenes extracted from the content, the temporal information including creation time of each scene, the thumbnail view including at least two thumbnails representative of first and second scenes, the first scene being an optional one of the extracted scenes, the second scene being another of the extracted scenes that is temporally next to the first scene according to the temporal information, the apparatus comprising:
a time difference calculator configured to calculate, according to the temporal information of the first and second scenes, a time difference between creation end time of the first scene and creation start time of the second scene;
a correlation value calculator configured to calculate, according to the calculated time difference, a correlation value for the temporal information of the first and second scenes;
a symbol generator configured to generate a symbol representing the calculated correlation value;
a thumbnail generator configured to generate the at least two thumbnails representing the first and second scenes; and
a display controller configured to display a thumbnail view showing the at least two thumbnails with the generated symbol arranged between the at least two thumbnails.

7. The display apparatus according to claim 6, wherein the display controller displays the thumbnail view showing at least three thumbnails spaced uniformly and symbols generated by the symbol generator and arranged between the at least three thumbnails.

8. The display apparatus according to claim 6, wherein the display controller displays the symbol having a spool shape with a center constriction, of which a width becomes longer as the correlation value becomes larger.

9. The display apparatus according to claim 6, wherein the display controller displays the symbol, of which a width becomes longer as the correlation value becomes larger.

10. The display apparatus according to claim 6, wherein the display controller displays the symbol, of which a position from a bottom side of the thumbnails becomes higher as the correlation value becomes larger.
